(19) United States
(12) Patent Application Publication
(10) Pub. No.: US 2018/0189301 A1
(43) Pub. Date: Jul. 5, 2018

(54) MANAGING APPENDABLE STATE OF AN IMMUTABLE FILE

(71) Applicant: HEWLETT PACKARD ENTERPRISE DEVELOPMENT LP, Houston, TX (US)

(72) Inventors: Rajkumar Kannan, Bangalore (IN); Ramesh Kannan Karuppusamy, Bangalore (IN); Arun Vishnu Pathanipadath Karthikeyan, Bangalore (IN)

(21) Appl. No.: 15/738,111

(22) PCT Filed: Sep. 22, 2015
(86) PCT No.: PCT/US2015/051390

§ 371 Date: Dec. 19, 2017

(30) Foreign Application Priority Data
Jul. 17, 2015 (IN) 3683/CHE/2015

(51) Int. Cl. G06F 17/30; G06F 21/62

(52) U.S. Cl. CPC G06F 17/30085; G06F 17/30188; G06F 21/6209; G06F 17/30073; G06F 17/30076

(57) ABSTRACT

Some examples described herein relate to managing appendable state of an immutable file. In an example, a request may be received to append an immutable file. A determination may be made whether the request is a first request to append immutable file. In response to determination that the request is the first request to append the immutable file, immutable file may be modified from an original state to an appendable state, wherein immutable file is appendable during the appendable state. A time period may be defined for immutable file to remain in the appendable state. A determination may be made whether immutable file is accessed during the time period. In response to determination that immutable file is not accessed during the time period, immutable file may be reverted from the appendable state to the original state upon expiration of the time period.

### BACKGROUND

Increased adoption of technology by businesses has led to an explosion of data. Organizations may be required to store data for various reasons. These may include business reasons, legal and compliance requirements, auditing functions, investigative purposes, etc. A retention enabled file system may allow users to apply retention settings on a file such that the file may be retained in a system for a period set by an administrator for the file.

### BRIEF DESCRIPTION OF THE DRAWINGS

For a better understanding of the solution, embodiments will now be described, purely by way of example, with reference to the accompanying drawings, in which:

FIG. 1 is a block diagram of an example system for managing appendable state of an immutable file;

FIG. 2 is a block diagram of an example system for managing appendable state of an immutable file;

FIG. 3 is a flowchart of an example method of managing appendable state of an immutable file;

FIG. 4 is a block diagram of an example system for managing appendable state of an immutable file.

### DETAILED DESCRIPTION

Data retention includes storing an organization's data for various reasons. These may include business or regulatory reasons. To ensure that relevant data is stored appropriately, an organization may define a data retention policy. The policy may include various guidelines related to data archival. For instance, these may relate to which data will be retained, where data will be retained, how long data will be retained, etc.

A retention enabled file system may allow users to retain files up to a hundred years or more. The files may be retained in an immutable form wherein the files cannot be changed or renamed. Examples of immutable files may include a WORM (Write Once Read Many) file and a WORM-retained file.

Typically, when a file becomes a WORM file or a WORM-retained file, a user may not be able to modify data or meta-data of the file. This may be desirable in certain scenarios, for instance, in case of log files and audit files. It may be preferable to keep such files as WORM or WORM-retained files so that a user is unable to modify the contents. However, a WORM file or a WORM-retained file may allow data to be appended. But keeping a WORM file or a WORM-retained file in an appendable state for an undefined period of time may make file validation a challenging job since file data and meta-data may change on every append operation. Further, an administrator may be expected to maintain a list of files with appendable state enabled, so that a validation scan may skip these files. An approach to managing an appendable state of an immutable file includes removing the append capability of the file once the append requirement of the file is complete. However, such approach may require a user intervention (for example, a system administrator) who may remove the append capability of a file after it is no longer desired.

To prevent these issues, the present disclosure describes various examples for managing appendable state of an immutable file. In an example, a request may be received to append an immutable file. Upon receipt, a determination may be made whether the request is a first request to append the immutable file. In response to the determination that the request is the first request to append the immutable file, the immutable file may be modified from an original state to an appendable state, so that the immutable file is appendable during the appendable state. A time period may be defined for the immutable file to remain in the appendable state, and a determination may be made whether the immutable file is accessed during the time period. In response to the determination that the immutable file is not accessed during the time period, the immutable file may be reversed from the appendable state to the original state upon expiration of the time period.

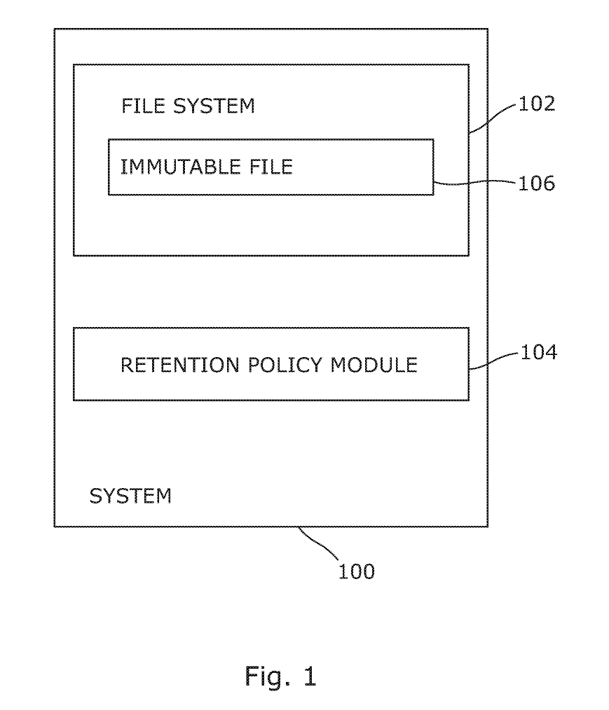

FIG. 1 is a block diagram of an example system 100 for managing appendable state of an immutable file. System 100 may represent any type of computing device capable of reading machine-executable instructions. Examples of computing device may include, without limitation, a server, a desktop computer, a notebook computer, a tablet computer, a thin client, a mobile device, a personal digital assistant (PDA), a phablet, and the like. In an example, system 100 may include a file server. In another example, system 100 may include a file retention system and/or file archive system.

In an example, system 100 may be a storage device or system. System 100 may be a primary storage device such as, but not limited to, random access memory (RAM), read only memory (ROM), processor cache, or another type of dynamic storage device that may store information and machine-readable instructions that may be executed by a processor. For example, Synchronous DRAM (SDRAM), Double Data Rate (DDR), Rambus DRAM (RDRAM), Rambus RAM, etc. System 100 may be a secondary storage device such as, but not limited to, a floppy disk, a hard disk, a CD-ROM, a DVD, a pen drive, a flash memory (e.g. USB flash drives or keys), a paper tape, an Iomega Zip drive, and the like. System 100 may be a tertiary storage device such as, but not limited to, a tape library, an optical jukebox, and the like. In another example, system 100 may be a Direct Attached Storage (DAS) device, a Network Attached Storage (NAS) device, a tape drive, a magnetic tape drive, a data archival storage system, or a combination of these devices.

Referring to FIG. 1, system 100 may include a file system 102. In general, file system 102 may be used for organization of data in system 100. In an instance, each piece of data may be called a “file”. File system 102 may be a local file system or a scale-out file system such as a shared file system or a network file system. Examples of a shared file system may include a Storage Area Network (SAN) file system or a cluster file system. Examples of a network file system may include a distributed file system or a distributed parallel file system. Some non-limiting examples of file systems that may be used on system 100 may include FAT (FAT12, FAT16, FAT32), NTFS, HFS and HFS+, HPFS, UFS, ext2, ext3, and ext4. In an instance, file system 102 may be an online file system.

In an example, file system 102 may allow files to be retained for a period of time. Such period may be called as a “retention period”. In an instance, the retention period may range from a few months to multiple years. In an instance, files in file system 100 may be retained in an immutable form, which may represent a “state” of the file. Files in an immutable form cannot be changed or renamed. The immutable state of a file may be managed by the file system 102. Examples of immutable states of files may include a WORM (Write Once Read Many) state and a WORM-retained state. In a WORM (Write Once Read Many) state, file data and meta-data cannot be changed. However, a file in WORM state may be deleted. In WORM-retained state, file data and meta-data cannot be changed. Also, a file in WORM-retained state may not be deleted. In an instance, a file in an immutable form may be called as an “immutable file”. Examples of an immutable file may include a WORM (Write Once Read Many) file and a WORM-retained file. A file in a WORM state may be called as a WORM file. File data and meta-data cannot be changed in a WORM file. However, a WORM file may be deleted. A file in a WORM-retained state may be called as a WORM-retained file. File data and meta-data cannot be changed in a WORM-retained file. Further, WORM-retained file may not be deleted. A WORM-retained file may retain its designation for a defined retention period.

File system 102 may receive a request to append an immutable file (for example, a WORM file or WORM-retained file) 106. In an example, the request to append an immutable file 106 is received at a file access time. In other words, when an immutable file is being accessed by file system 100. In an instance, the request may be received from a general user or a specific user (for example, a system administrator). Upon receipt of the request, file system 102 may determine whether the request is a first request from a user to append the immutable file. In an instance, file system 102 may make the aforesaid determination from a retention profile of the user. In response to the determination that the request is the first request from the user to append the immutable file, file system 102 may modify the immutable file from an original state to an appendable state. The immutable file 106 may become appendable during the appendable state. In other words, the immutable file may allow the user to perform an append operation(s) on the file. Data may be added to the immutable file 106 when the file is in the appendable state.

In response to the determination that the request is not the first request from the user to append the immutable file, file system 102 may determine from the retention profile of the user whether the request is within a limit defined for the user to make the request to append the immutable file. In an instance, a user may be permitted to make a request to append an immutable file only up to a certain number of times. In other words, a limit may be defined for a user to request transition of an immutable file from an original state to an appendable state. In an instance, the limit may be set in the retention profile of the user. File system 102 may refer to the retention profile of a user to determine whether the user's request to append the immutable file is within the limit defined for the user. In response to the determination that the user is within the limit, file system 102 may modify the immutable file from an original state to an appendable state. On the other hand, if file system 102 determines that the user has reached the limit defined for the user, file system may decline the request from the user to modify the immutable file from an original state to an appendable state.

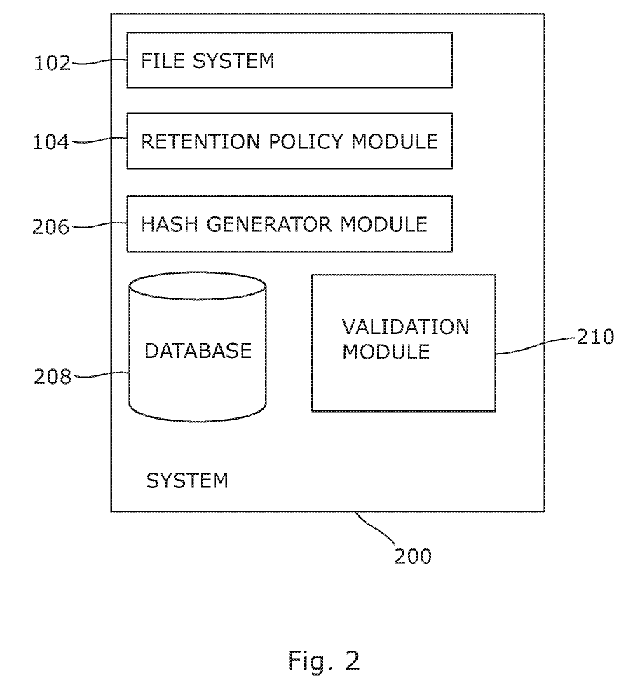

File system 102 may define a time period for the immutable file 106 to remain in the appendable state. The time period states a time limit during which the immutable file may be appended. In an example, the time period defined for the immutable file to remain in the appendable state may be stored as an extended file attribute of the immutable file. In another example, the time period may be stored in a retention policy module 104 (described further with reference to FIG. 2 below) separate from the file system 102. File system 102 may determine whether the immutable file is accessed during the time period defined for the immutable file to remain in the appendable state. In response to the determination that the immutable file is not accessed during the time period, file system 102 may revert the immutable file from the appendable state to the original state upon expiration of the time period. In other words, file system 102 may revoke the appendable state of the immutable file and restore the file to its original immutable state. For example, if the immutable file was modified from a WORM state to an appendable state, file system 102 may change the state of the immutable file to the original WORM state. Likewise, if the immutable file was modified from a WORM-retained state to an appendable state, file system 102 may change the state of the immutable file to the WORM-retained state. In an instance, file system 102 may revert the immutable file from the appendable state to the original state upon first file access of the immutable file after the expiration of the time period. The first file access may be carried out by a user or a system process. Also, in an instance, file system 102 may restrict further modification of an immutable file from an original state to an appendable state once the time period defined for the immutable file to remain in the appendable state is over.

If file system 102 determines that the immutable file is accessed during the time period, file system may reset the time period for the immutable file to remain in the appendable state. In an instance, the time period may be reset to previously defined time period, beginning from time the immutable file was last accessed during the time period. For example, let's assume that the time period defined for the immutable file to remain in the appendable state is seven days. In this case, if the file is accessed on the first and third day of the period, file system may reset the time period for the immutable file to remain in the appendable state to another seven days, beginning from the third day of the period when the immutable file was last accessed.

In an example, a limit may be defined on the number of processes that may simultaneously access an immutable file during the appendable state. The limit may be defined by a user. In an instance, the aforesaid limit may be stored as an extended file attribute of the immutable file. In another example, the aforesaid limit may be stored in retention policy module 104. When an immutable file is in an appendable state, file system 102 may refer to the aforesaid limit to restrict the number of processes that may simultaneously access the immutable file, for instance, to append data to the file. In response to the determination that the limit on number of processes that may simultaneously access the immutable file during the appendable state is reached, file system 102 may restrict further access to the immutable file during the appendable state.

FIG. 2 is a block diagram of an example system 200 for managing appendable state of an immutable file. System 200 may be analogous to system 100, in which like reference numerals correspond to the same or similar, though perhaps not identical, components. For the sake of brevity, component(s) or reference numeral(s) of FIG. 2 having a same or similarly described function in FIG. 1 is/are not being described in connection with FIG. 2. Said component(s) or reference numeral(s) may be considered alike.

In the example of FIG. 2, system 200 may include a file system 102, a retention policy module 104, a hash generator module 206, a database 208 and a validation module 210. In an example, system 200 may be a distributed computer system. In other words, “system” 200 may include multiple computing devices that may host one or more of the aforementioned components (for example, file system 102) that may interact with each other in order to achieve a common goal. The multiple computing devices may be in communication, for example, via a computer network. Such a computer network may be a wireless or wired network. Such a computer network may include, for example, a Local Area Network (LAN), a Wireless Local Area Network (WAN), a Metropolitan Area Network (MAN), a Storage Area Network (SAN), a Campus Area Network (CAN), or the like. Further, such a computer network may be a public network (for example, the Internet) or a private network (for example, an intranet).

The term “module” may refer to a software component (machine readable instructions), a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. A module may reside on a volatile or non-volatile storage medium and configured to interact with a processor of a computing device (e.g. 100).

Retention policy module 104 may store the retention profile of a user. The retention profile of a user defines the limit for a user to request transition of an immutable file from an original state to an appendable state. In an instance, a user may be permitted to make a request to append an immutable file only up to a certain number of times. The retention profile of a user defines that limit. When a user makes a request to append an immutable file, file system 102 may refer to the retention profile of the user in the retention policy module 104 to determine whether the user's request to append the immutable file is within the limit defined for the user.

Retention policy module 104 may store the time period defined for an immutable file to remain in an appendable state. In other words, retention policy module 104 may store the time limit during which data may be appended to an immutable file. File system 102 may refer to the retention policy module 104 to determine the time period defined for an immutable file to remain in an appendable state.

Retention policy module 104 may store the limit defined on the number of processes that may simultaneously access an immutable file during the appendable state. The limit may be defined by a user. When an immutable file is in an appendable state, file system 102 may refer to the aforesaid limit in the retention policy module to restrict the number of processes that may simultaneously access the immutable file. In response to the determination that the limit on number of processes simultaneously accessing the immutable file during the appendable state is reached, file system 102 may restrict further access to the immutable file during the appendable state.

Hash generator module 206 may generate a baseline checksum of an immutable file before an immutable file is appended in an appendable state. In other words, in a scenario where file system 102 may modify an immutable file from an original state to an appendable state, then before the immutable file is appended, hash generator module may generate a checksum of the immutable file. A checksum (hash) of an immutable file in an appendable state may be generated using a hash algorithm. In an instance, the baseline checksum may be stored in a database (example, 208). Some non-limiting examples of hash algorithms that may be used for generating a checksum of an immutable file in an appendable state may include Secure Hash Algorithm (for example, SHA and SHA-1), and Message Digest Algorithms (for example, MD2, MD4, and MD5).

Database 208 may be a repository that stores a checksum of an immutable file in an appendable state, wherein the checksum may be generated before the immutable file is appended for the first time.

Validation module 210 may be used to perform a validation scan on an immutable file once the time period defined for the immutable file to remain in an appendable state has lapsed. During such validation scan, validation module 210 may refer to the baseline checksum of the immutable file stored in database 208. Since checksum of an immutable file may change after the file is appended in the appendable state, referring to the baseline checksum of the immutable file may allow the immutable file to participate in a validation scan that may be performed to protect a retained file (for example, a WORM file or WORM-retained file).

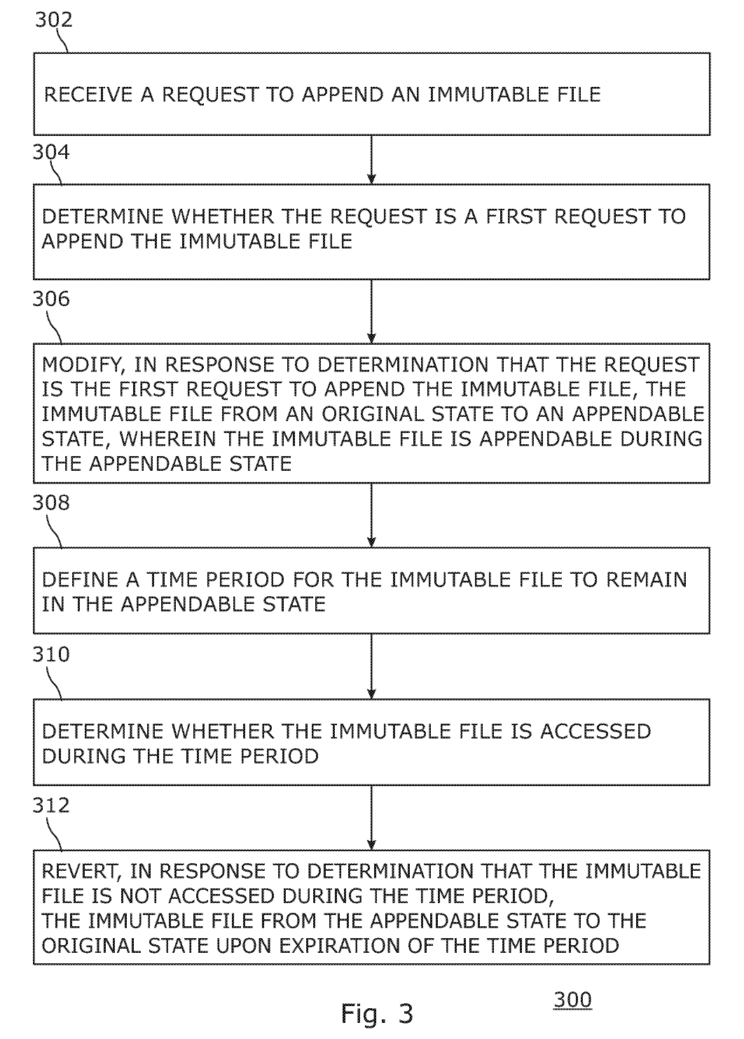

FIG. 3 is a flowchart of an example method 300 of managing appendable state of an immutable file. The method 300, which is described below, may at least partially be executed on system 100 and 200 of FIGS. 1 and 2, respectively. However, other computing devices may be used as well. At block 302, a request may be received to append an immutable file. At block 304, a determination may be made whether the request is a first request to append the immutable file. At block 306, in response to the determination that the request is the first request to append the immutable file, the immutable file may be modified from an original state to an appendable state, wherein the immutable file is appendable during the appendable state. On the other hand, in response to the determination that the request is not the first request to append the immutable file, a determination may be made if the request is provided by a specific user (for example, a system administrator). In response to the determination that the request is provided by a specific user, the immutable file may be modified from the original state to the appendable state. At block 308, a time period may be defined for the immutable file to remain in the appendable state. At block 310, a determination may be made whether the immutable file is accessed during the time period. At block 312, in response to the determination that the immutable file is not accessed during the time period, the immutable file may be reverted from the appendable state to the original state upon expiration of the time period.

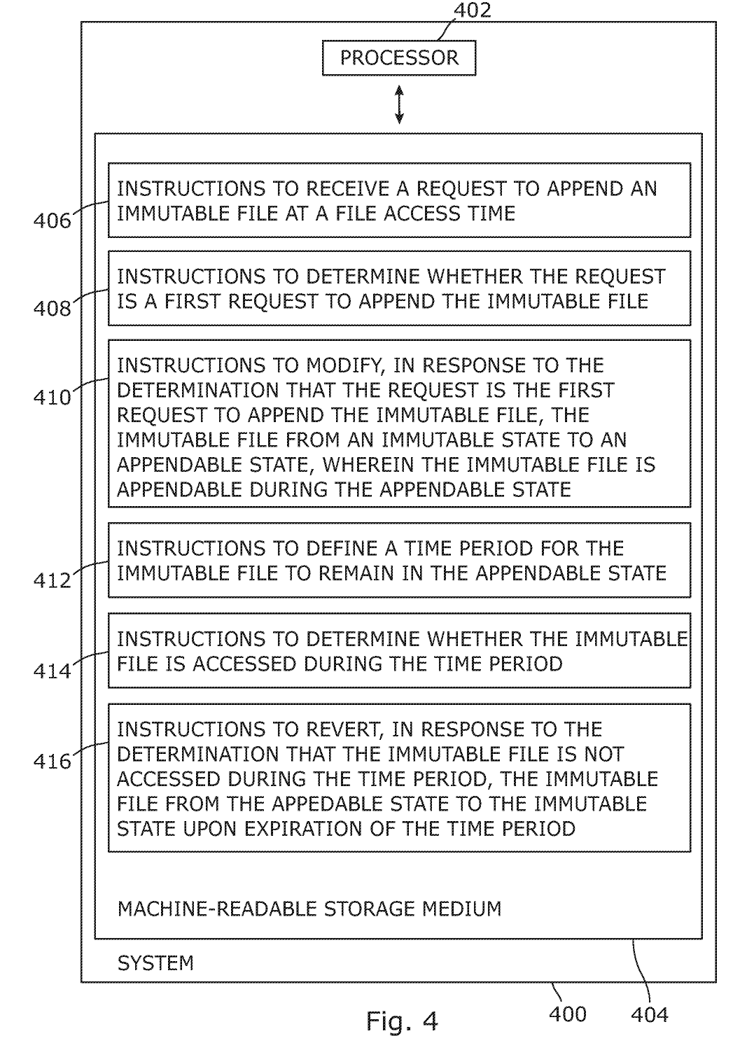

FIG. 4 is a block diagram of an example system 400 for managing appendable state of an immutable file. System 400 includes a processor 402 and a machine-readable storage medium 404 communicatively coupled through a system bus. In an example, system 400 may be analogous to system 100 of FIG. 1 or system 200 of FIG. 2. Processor 402 may be any type of Central Processing Unit (CPU), microprocessor, or processing logic that interprets and executes machine-readable instructions stored in machine-readable storage medium 404. Machine-readable storage medium 404 may be a random access memory (RAM) or another type of dynamic storage device that may store information and machine-readable instructions that may be executed by processor 402. For example, machine-readable storage medium 404 may be Synchronous DRAM (SDRAM), Double Data Rate (DDR), Rambus DRAM (RDRAM), Rambus RAM, etc. or a storage memory media such as a floppy disk, a hard disk, a CD-ROM, a DVD, a pen drive, and the like. In an example, machine-readable storage medium 404 may be a non-transitory machine-readable medium. Machine-readable storage medium 404 may store instructions 406, 408, 410, 412, 414, and 416. In an example, instructions 406 may be executed by processor 402 to receive a request to append an immutable file at a file access time. Instructions 408 may be executed by processor 402 to determine whether the request is a first request to append the immutable file. Instructions 410 may be executed by processor 402 to modify, in response to the determination that the request is the first request to append the immutable file, the immutable file from an immutable state to an appendable state, wherein the immutable file is appendable during the appendable state. Instructions 412 may be executed by processor 402 to define a time period for the immutable file to remain in the appendable state. Instructions 414 may be executed by processor 402 to determine whether the immutable file is accessed during the time period. Instructions 416 may be executed by processor 402 to revert, in response to the determination that the immutable file is not accessed during the time period, the immutable file from the appendable state to the immutable state upon expiration of the time period.

For the purpose of simplicity of explanation, the example method of FIG. 3 is shown as executing serially, however it is to be understood and appreciated that the present and other examples are not limited by the illustrated order. The example systems of FIGS. 1, 2 and 4, and method of FIG. 3 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

1. A method of managing appendable state of an immutable file, comprising:
receiving a request to append an immutable file;
determining whether the request is a first request to append the immutable file;
in response to determining that the request is the first request to append the immutable file, modifying the immutable file from an original state to an appendable state, wherein the immutable file is appendable during the appendable state;
defining a time period for the immutable file to remain in the appendable state;
determining whether the immutable file is accessed during the time period; and
in response to determining that the immutable file is not accessed during the time period, reverting the immutable file from the appendable state to the original state upon expiration of the time period.

2. The method of claim 1, wherein the immutable file includes a WORM file.

3. The method of claim 1, wherein the immutable file includes a WORM-retained file.

4. The method of claim 1, further comprising:
in response to determining that the request is not the first request to append the immutable file, determining if the request is provided by a specific user; and
in response to determining that the request is provided by the specific user, modifying the immutable file from the original state to the appendable state.

5. The method of claim 1, further comprising, in response to determining that the immutable file is accessed during the time period, resetting the time period for the immutable file to remain in the appendable state to the defined time period, beginning from time the immutable file was last accessed during the time period.

6. A system for managing appendable state of an immutable file, comprising:
a file system to:
receive a request from a user to append an immutable file;
determine whether the request is a first request from the user to append the immutable file;
in response to the determination that the request is the first request from the user to append the immutable file, modify the immutable file from an original state to an appendable state, wherein the immutable file is appendable during the appendable state;
determine, from a retention policy module, a time period for the immutable file to remain in the appendable state;
determine whether the immutable file is accessed during the time period; and
in response to the determination that the immutable file is not accessed during the time period, revert the immutable file from the appendable state to the original state upon expiration of the time period.

7. The system of claim 6, wherein the file system is further to:
in response to the determination that the request is not the first request from the user to append the immutable file, determine from a retention profile of the user whether the request is within a limit defined for the user to make the request to append the immutable file;
in response to the determination that the user is within the limit defined for the user to make the request to append the immutable file, modify the immutable file from the original state to the appendable state; and
in response to the determination that the user has reached the limit defined for the user to make the request to append the immutable file, decline the request from the user to modify the immutable file from the original state to the appendable state.

8. The system of claim 7, wherein the retention policy module is further to store the retention profile of the user.

9. The system of claim 6, wherein:
the retention policy module is further to store a limit defined on number of processes that are allowed to simultaneously access the immutable file during the appendable state; and
in response to a determination that the limit on number of processes that are allowed to simultaneously access the immutable file during the appendable state is reached, the file system is to restrict further access to the immutable file during the appendable state.

10. The system of claim 6, further comprising:
a hash generator module to generate a baseline checksum of the immutable file prior to appending the immutable file during the appendable state; and
a validation module to use the baseline checksum of the immutable file to validate the immutable file during a validation scan performed subsequent to the time period.

11. The system of claim 10, further comprising a database to store the baseline checksum of the immutable file.

12. A non-transitory machine-readable storage medium comprising instructions for managing appendable state of an immutable file, the instructions executable by a processor to:
receive a request to append an immutable file at a file access time;
determine whether the request is a first request to append the immutable file;
in response to the determination that the request is the first request to append the immutable file, modify the immutable file from an immutable state to an appendable state, wherein the immutable file is appendable during the appendable state;
define a time period for the immutable file to remain in the appendable state;
determine whether the immutable file is accessed during the time period; and
in response to the determination that the immutable file is not accessed during the time period, revert the immutable file from the appendable state to the immutable state upon expiration of the time period.

13. The storage medium of claim 12, further comprising instructions to revert the immutable file from the appendable state to the original state upon first file access of the immutable file after the expiration of the time period.

14. The storage medium of claim 12, further comprising instructions to store the time period defined for the immutable file to remain in the appendable state as an extended file attribute of the immutable file.

15. The storage medium of claim 12, further comprising instructions to restrict further modification of the immutable file from the original state to the appendable state subsequent to completion of the time period defined for the immutable file to remain in the appendable state.
